(19) United States
(12) Patent Application Publication
(10) Pub. No.: US 2026/0258194 A1
(43) Pub. Date: Sep. 3, 2026

(54) POLYESTER COPOLYMER

(71) Applicant: SK CHEMICALS CO., LTD., Gyeonggi-do (KR)

(72) Inventors: Yong-Jun SHIN, Gyeonggi-do (KR); Sung-Gi KIM, Gyeonggi-do (KR); Se-Ho LEE, Gyeonggi-do (KR)

(21) Appl. No.: 19/165,141

(22) PCT Filed: Mar. 5, 2024
(86) PCT No.: PCT/KR2024/095472

§ 371 Date: Sep. 15, 2025

(30) Foreign Application Priority Data
Mar. 15, 2023 (KR) 10-2023-0033829

(51) Int. Cl. C08G 63/199

(52) U.S. Cl. CPC C08G 63/199

(57) ABSTRACT

The present invention relates to an environmentally-friendly polyester copolymer. Specifically, according to one embodiment of the present invention, the polyester copolymer comprises: a moiety of a first dicarboxylic acid component including terephthalic acid or a derivative thereof; a moiety of a second dicarboxylic acid component including cyclohexane dicarboxylic acid, dimethyl cyclohexane dicarboxylate or a derivative thereof; and a moiety of a diol component including ethylene glycol or a derivative thereof, and comprises 30 mol % or higher of the second dicarboxylic acid component on the basis of the total dicarboxylic acid components, and thus is environmentally-friendly and has mechanical properties such as softness and elasticity, optical properties such as transparency and UV stability, and processability, which are all excellent.

### TECHNICAL FIELD

The present invention relates to a polyester copolymer that is environmentally friendly and has excellent quality and processability.

### BACKGROUND ART

Polyvinyl chloride (PVC) is colorless and transparent, has excellent strength, and is easy to adjust the desired physical properties depending on the type of additives mixed during processing; thus, it is used in various industrial fields. For example, as a certain amount of a plasticizer, which is a softening component to PVC, is added, it is possible to produce soft PVC that can be used to make flexible products such as packaging films, shower curtains, and the like. When 10% by weight or less of a plasticizer is added, hard PVC, such as plumbing materials, can be produced. As described above, PVC has excellent productivity and processability in that softness and hardness can be easily controlled by simply adjusting the content of a plasticizer without additional processes. In recent years, however, there has been controversy over the phthalic acid-based and adipic acid-based substances used as plasticizers being harmful to the environment and the human body; thus, their use is restricted. In addition, since PVC produces dioxin, a toxic substance, when burned, there is no way to dispose of it other than landfill. Accordingly, it is needed to develop materials that can replace PVC.

Meanwhile, since polyester has excellent mechanical properties such as durability and thermal resistance, and excellent optical properties such as transparency, it is widely used in various industrial materials such as display devices, as well as materials such as fibers, films, packaging materials, molded articles, building materials, and interior and exterior materials. In addition, polyester is attracting attention as a material that can replace PVC: for, it is environmentally friendly since it can reuse resources through methods such as mechanical recycling and chemical recycling and has excellent mechanical and optical properties as compared with PVC. However, it is not easy to control softness or hardness. Accordingly, research on polyester that can effectively control softness and hardness continues.

As an example, Korean Laid-open Patent Publication No. 2013-0122746 discloses a copolyester resin that can control softness or hardness by attaching soft segments or hard segments.

### PRIOR ART DOCUMENT

### Patent Document

(Patent Document 1) Korean Laid-open Patent Publication No. 2013-0122746

### DETAILED DESCRIPTION OF THE INVENTION

### Technical Problem

Accordingly, the present invention aims to provide a polyester copolymer that is environmentally friendly, has excellent quality and processability, is transparent, has excellent weatherability, can effectively control softness and hardness, and has excellent elasticity.

### Solution to the Problem

The polyester copolymer according to an embodiment of the present invention comprises a residue of a first dicarboxylic acid component comprising terephthalic acid or a derivative thereof; a residue of a second dicarboxylic acid component comprising cyclohexane dicarboxylic acid, dimethyl cyclohexane dicarboxylate, or a derivative thereof; and a residue of a diol component comprising ethylene glycol or a derivative thereof, wherein the second dicarboxylic acid component is employed in an amount of 30% by mole or more based on the total dicarboxylic acid component.

### Advantageous Effects of the Invention

The polyester copolymer according to an embodiment of the present invention comprises a residue of a first dicarboxylic acid component comprising terephthalic acid or a derivative thereof; a residue of a second dicarboxylic acid component comprising cyclohexane dicarboxylic acid, dimethyl cyclohexane dicarboxylate, or a derivative thereof; and a residue of a diol component comprising ethylene glycol or a derivative thereof, wherein the second dicarboxylic acid component is employed in an amount of 30% by mole or more based on the total dicarboxylic acid component. As a result, it is environmentally friendly and is excellent in all of its mechanical properties such as softness and elasticity, optical properties such as transparency and UV stability, and processability.

### BEST MODE FOR CARRYING OUT THE INVENTION

Hereinafter, the present invention will be described in detail. The present invention is not limited to the disclosures given below, but it may be modified into various forms as long as the gist of the invention is not changed.

Throughout the present specification, when a part is referred to as “comprising” an element, it is understood that other elements may be comprised, rather than other elements are excluded, unless specifically stated otherwise.

All numbers and expressions related to the quantities of components, reaction conditions, and the like used herein are to be understood as being modified by the term “about,” unless otherwise indicated.

Throughout the present specification, the terms first, second, and the like are used to describe various components. But the components should not be limited by the terms. The terms are used only for the purpose of distinguishing one component from another.

The term “derivative thereof” as used herein refers to a compound that has been changed from a parent compound by introduction of functional groups, oxidation, reduction, or substitution of atoms to the extent that the structure and properties of the parent compound are not significantly changed.

### Polyester Copolymer

The polyester copolymer according to an embodiment of the present invention comprises a residue of a first dicarboxylic acid component comprising terephthalic acid or a derivative thereof; a residue of a second dicarboxylic acid component comprising cyclohexane dicarboxylic acid, dimethyl cyclohexane dicarboxylate, or a derivative thereof; and a residue of a diol component comprising ethylene glycol or a derivative thereof, wherein the second dicarboxylic acid component is employed in an amount of 30% by mole or more based on the total dicarboxylic acid component.

Specifically, the polyester copolymer is one in which a first dicarboxylic acid component, a second dicarboxylic acid component, and a diol component comprising ethylene glycol or a derivative thereof are copolymerized. It may be a block copolymer or a random copolymer comprising a residue of the first dicarboxylic acid component, a residue of the second dicarboxylic acid component, and a residue of the diol component comprising ethylene glycol or a derivative thereof.

The first dicarboxylic acid component comprises terephthalic acid (TPA) or a derivative thereof. Specifically, the first dicarboxylic acid component may comprise terephthalic acid or a derivative thereof in an amount of 80% by mole or more, 85% by mole or more, 90% by mole or more, 95% by mole or more, 98% by mole or more, 99% by mole or more, or 100% by mole.

In addition, the polyester copolymer may comprise the first dicarboxylic acid component in an amount of 5% by mole to 70% by mole, 8% by mole to 65% by mole, 10% by mole to 60% by mole, 13% by mole to 55% by mole, or 15% by mole to 50% by mole, based on the total dicarboxylic acid component.

According to an embodiment of the present invention, the second dicarboxylic acid component comprises cyclohexane dicarboxylic acid (CHDA), dimethyl cyclohexane dicarboxylate (DMCD), or a derivative thereof. More specifically, the second dicarboxylic acid component may be 1,4-cyclohexane dicarboxylic acid, dimethyl 1,4-cyclohexane dicarboxylate, or a derivative thereof.

The polyester copolymer according to an embodiment of the present invention comprises, as a dicarboxylic acid component, both of a first dicarboxylic acid component comprising terephthalic acid or a derivative thereof; and a second dicarboxylic acid component comprising cyclohexane dicarboxylic acid, dimethyl cyclohexane dicarboxylate, or a derivative thereof; thus, it is environmentally friendly and can be enhanced in all of its mechanical properties such as hardness and elasticity, optical properties such as transparency and UV stability, and processability. In particular, since softness can be effectively controlled by adjusting the content of the second dicarboxylic acid component, productivity and processability are very excellent.

Specifically, the second dicarboxylic acid component comprises cyclohexane dicarboxylic acid, dimethyl cyclohexane dicarboxylate, or a derivative thereof. Specifically, the second dicarboxylic acid component may comprise cyclohexane dicarboxylic acid, dimethyl cyclohexane dicarboxylate, or a derivative thereof in an amount of 80% by mole or more, 85% by mole or more, 90% by mole or more, 95% by mole or more, 98% by mole or more, 99% by mole or more, or 100% by mole.

In addition, the polyester copolymer may comprise the second dicarboxylic acid component in an amount of 20% by mole or more, 25% by mole or more, 30% by mole or more, or 50% by mole or more, and 100% by mole or less, 95% by mole or less, or 90% by mole or less, based on the total dicarboxylic acid component. As the content of the second dicarboxylic acid component satisfies the above range, the softness of the polyester copolymer can be further enhanced.

More specifically, the second dicarboxylic acid component may be dimethyl cyclohexane dicarboxylate, and the polyester copolymer may comprise the dimethyl cyclohexane dicarboxylate in an amount of 20% by mole or more, 25% by mole or more, 30% by mole or more, 35% by mole or more, 45% by mole or more, 50% by mole or more or 60% by mole or more, and 100% by mole or less, 95% by mole or less, or 90% by mole or less, based on the total dicarboxylic acid component. As the content of dimethyl cyclohexane dicarboxylate or a derivative thereof satisfies the above range, the softness of the polyester copolymer can be further enhanced.

Alternatively, the second dicarboxylic acid component may be cyclohexane dicarboxylic acid, and the polyester copolymer may comprise the cyclohexane dicarboxylic acid in an amount of 20% by mole or more, 25% by mole or more, or 30% by mole or more, and 100% by mole or less, 95% by mole or less, or 90% by mole or less, based on the total dicarboxylic acid component.

According to another embodiment of the present invention, the polyester copolymer may comprise a residue of a third dicarboxylic acid component.

Specifically, the third dicarboxylic acid component may be a dicarboxylic acid component different from the first dicarboxylic acid component and the second dicarboxylic acid component. More specifically, the third dicarboxylic acid may comprise at least one selected from the group consisting of succinic acid, adipic acid, sebacic acid, azelaic acid, dodecanoic acid, isophthalic acid, orthophthalic acid, naphthalenedicarboxylic acid, dimethyl terephthalate, dimethyl isophthalate, diethyl terephthalate, diethyl isophthalate, dibutyl terephthalate, and dibutyl isophthalate.

In addition, the polyester copolymer may comprise the third dicarboxylic acid component in an amount of 30% by mole or less, 25% by mole or less, 15% by mole or less, 10% by mole or less, 5% by mole or less, 3% by mole or less, or 1% by mole or less, based on the total dicarboxylic acid component.

The diol component comprises ethylene glycol or a derivative thereof. Specifically, the diol component may comprise ethylene glycol or a derivative thereof in an amount of 80% by mole or more, 85% by mole or more, 90% by mole or more, 95% by mole or more, 98% by mole or more, 99% by mole or more, or 100% by mole.

According to another embodiment of the present invention, the polyester copolymer comprises a residue of a first diol component comprising the ethylene glycol or a derivative thereof, and it may comprise a residue of a second diol component that is different from the first diol component.

Specifically, the second diol component may comprise at least one selected from the group consisting of propanediol, butanediol, pentanediol, hexanediol, cyclohexanedimethanol, neopentyl glycol, diethylene glycol, and triethylene glycol. For example, the second diol component may comprise at least one selected from the group consisting of 1,2-propanediol, 1,3-propanediol, 1,2-butanediol, 1,4-butanediol, 1,5-pentanediol, 1,2-hexanediol, 1,3-hexanediol, 1,4-hexanediol, 1,6-hexanediol, 2,3-hexanediol, 2,4-hexanediol, 2,5-hexanediol, 2,6-hexanediol, 3,4-hexanediol, 1,2-cyclohexanedimethanol, 1,3-cyclohexanedimethanol, and 1,4-cyclohexanedimethanol.

In addition, the polyester copolymer may comprise the first diol component in an amount of 80% by mole or more, 85% by mole or more, 90% by mole or more, 95% by mole or more, 98% by mole or more, 99% by mole or more, or 100% by mole.

In addition, the polyester copolymer may comprise the second diol component in an amount of 30% by mole or less, 25% by mole or less, 15% by mole or less, 10% by mole or less, 5% by mole or less, 3% by mole or less, 2% by mole or less, or 1% by mole or less, based on the total diol component.

According to an embodiment of the present invention, the polyester copolymer may have a glass transition temperature (Tg) of 10° C. to 70° C. when measured by differential scanning calorimetry (DSC). For example, the glass transition temperature (Tg) of the polyester copolymer may be 13° C. to 68° C. or 15° C. to 65° C. when measured by differential scanning calorimetry (DSC).

The polyester copolymer may have an intrinsic viscosity (IV) of 0.5 dl/g to 1.3 dl/g. For example, the intrinsic viscosity (IV) of the polyester copolymer may be 0.55 dl/g to 1.2 dl/g or 0.6 dl/g to 1.15 dl/g.

The polyester copolymer may have a specific gravity of 1.2 or more. For example, the specific gravity of the polyester copolymer may be 1.21 or more or 1.22 or more.

The polyester copolymer may have a Shore D hardness of 20 to 95. For example, the Shore D hardness of the polyester copolymer may be 23 to 93, 25 to 81, 30 to 90, 32 to 78, or 35 to 75.

The polyester copolymer may have a tensile strength (@ break) of 10 MPa to 70 MPa.

Specifically, tensile strength and tensile elongation may be divided into measurement values at the yield point and measurement values at the break point. Yield point refers to the force at the highest point received by a material (object of measurement). Break point refers to the force at which a material (object of measurement) breaks. In the present specification, the tensile strength and tensile elongation at the yield point are indicated by @ yield, and tensile strength and tensile elongation at the break point are indicated by @ break.

For example, the tensile strength (@ break) of the polyester copolymer may be 12 MPa to 68 MPa, 14 MPa to 66 MPa, or 15 MPa to 65 MPa. In addition, the polyester copolymer has excellent elasticity, so that the tensile strength at the yield point may not be measured.

The polyester copolymer may have a tensile elongation (@ break) of 200% to 3,500%. For example, the tensile elongation (@ break) of the polyester copolymer may be 300% to 3,300%, 500% to 3,000%, or 600% to 2,500%. In addition, the polyester copolymer has excellent elasticity, so that the tensile elongation at the yield point may not be measured.

### Process for Preparing a Polyester Copolymer

The process for preparing a polyester copolymer according to an embodiment of the present invention comprises mixing a first dicarboxylic acid component comprising terephthalic acid or a derivative thereof, a second dicarboxylic acid component comprising cyclohexane dicarboxylic acid, dimethyl cyclohexane dicarboxylate, or a derivative thereof, and a diol component comprising ethylene glycol or a derivative thereof; subjecting the mixture to an esterification reaction; and subjecting the product of the esterification reaction to a polycondensation reaction, wherein the polyester copolymer comprises the second dicarboxylic acid component in an amount of 30% by mole or more based on the total dicarboxylic acid component.

A polyester copolymer prepared according to the process for preparing a polyester copolymer has substantially the same composition and characteristics as those of the polyester copolymer described above.

In addition, the composition and process conditions may be adjusted, so that the polyester copolymer finally prepared according to the process for preparing a polyester copolymer satisfies the mechanical properties such as softness and elasticity, optical properties such as transparency and UV stability, and characteristics such as processability as described above.

First, a first dicarboxylic acid component comprising terephthalic acid or a derivative thereof, a second dicarboxylic acid component comprising cyclohexane dicarboxylic acid, dimethyl cyclohexane dicarboxylate, or a derivative thereof, and a diol component comprising ethylene glycol or a derivative thereof are mixed.

Descriptions on the first dicarboxylic acid component, second dicarboxylic acid component, and diol component are as described above. Specifically, the first dicarboxylic acid component, the second dicarboxylic acid component, and the diol component are mixed to produce a mixture.

According to another embodiment of the present invention, at least one additive selected from the group consisting of a colorant, a crystallizing agent, an oxidation stabilizer, and a branching agent may be added to a mixture of the first dicarboxylic acid component, the second dicarboxylic acid component, and the diol component.

The colorant is an additive for enhancing the color characteristics of the polyester copolymer. Commonly used colorants such as cobalt acetate and cobalt propionate may be used as the colorant as long as the effects of the present invention are not impaired.

Specifically, the colorant may be cobalt acetate, cobalt propionate, anthraquinone-based compounds, perinone-based compounds, azo-based compounds, and methine-based compounds. Commercially available toners such as Polysynthren Blue RLS (manufacturer: Clariant) or Solvaperm Red BB (manufacturer: Clariant) may be used.

In addition, the polyester copolymer may comprise the colorant in an amount of 0.1 ppm to 30 ppm based on the total weight of the polyester copolymer. For example, the colorant may be employed in an amount of 0.2 ppm to 30 ppm, 0.5 ppm to 25 ppm, 0.6 ppm to 23 ppm, or 0.8 ppm to 20 ppm, based on the total weight of the mixture. As the content of the colorant satisfies the above range, the color characteristics of the polyester copolymer may be sufficiently enhanced without deteriorating its mechanical properties.

The crystallizing agent may comprise at least one selected from the group consisting of a crystal nucleating agent, a UV absorber, a polyolefin resin, a polyamide resin, a polyester resin, a polyester elastomer resin, and a polyalkylene resin.

In addition, the polyester copolymer may comprise the crystallizing agent in an amount of 0.1 ppm to 20% by weight based on the total weight of the polyester copolymer. For example, the crystallizing agent may be employed in an amount of 0.2 ppm to 20% by weight, 0.5 ppm to 15% by weight, 1 ppm to 10% by weight, 2 ppm to 8% by weight, 3 ppm to 5% by weight, or 4 ppm to 1% by weight, based on the total weight of the mixture. As the content of the crystallizing agent satisfies the above range, mechanical properties such as thermal resistance and impact strength can be enhanced.

The oxidation stabilizer may comprise at least one selected from the group consisting of phosphorus-based, hindered phenol-based, phosphite-based, and thioether-based compounds.

In addition, the polyester copolymer may comprise the oxidation stabilizer in an amount of 50 ppm to 2,500 ppm based on the total weight of the polyester copolymer. For example, the oxidation stabilizer may be employed in an amount of 50 ppm to 2,300 ppm, 60 ppm to 2,200 ppm, 80 ppm to 2,100 ppm, 100 ppm to 2,000 ppm, or 100 ppm to 1,500 ppm, based on the total weight of the mixture. As the content of the oxidation stabilizer satisfies the above range, it is possible to effectively prevent a decrease in intrinsic viscosity that may occur in a subsequent process and to prevent a decrease in physical properties such as impact strength as well.

The branching agent may comprise at least one selected from the group consisting of trimellitic anhydride, trimethylol propane, trimellitic acid, and glycerol.

In addition, the polyester copolymer may comprise the branching agent in an amount of 10 ppm to 5,000 ppm based on the total weight of the polyester copolymer. For example, the branching agent may be employed in an amount of 20 ppm to 4,000 ppm or 30 ppm to 3,000 ppm, based on the total weight of the mixture. As the content of the branching agent satisfies the above range, the intrinsic viscosity may be more effectively controlled within a specific range, so that such physical properties as impact strength may be enhanced as well.

Thereafter, the mixture is subjected to an esterification reaction.

Specifically, the mixture of the first dicarboxylic acid component, the second dicarboxylic acid component, and the diol component is subjected to an esterification reaction.

The esterification reaction may be carried out at normal pressure or a pressure higher than normal pressure by 0.1 kg/cm² to 3.0 kg/cm² and a temperature of 245° C. to 275° C. for 2 hours to 12 hours.

Specifically, the pressure may be higher than normal pressure by 0.1 kg/cm² to 3.0 kg/cm², 0.2 kg/cm² to 2.5 kg/cm², or 0.3 kg/cm² to 2.0 kg/cm². In addition, the esterification reaction may be carried out at a temperature of 150° C. to 275° C., 155° C. to 275° C., or 160° C. to 270° C., for 2 hours to 12 hours, 2 hours to 11 hours, or 2.5 hours to 10 hours.

For example, the esterification reaction may be carried out at normal pressure or a pressure higher than normal pressure by 0.1 kg/cm² to 3.0 kg/cm², while the temperature is raised from room temperature to 150° C. to 275° C. or 155° C. to 270° C. for 30 minutes to 110 minutes or 30 minutes to 100 minutes, it is maintained for 0.5 hour to 3 hours or 0.5 hour to 2.5 hours, or the temperature is raised to 150° C. to 275° C. or 155° C. to 270° C. for 2 hour to 12 hours continuously or stepwise.

Upon completion of the esterification reaction, the pressure of the reactor in a pressurized state is lowered to normal pressure, and then a polycondensation reaction to be described below may be carried out.

Finally, the product of the esterification reaction is subjected to a polycondensation reaction.

The polycondensation reaction may be carried out at a pressure of 0.00001 mmHg to 400 mmHg and a temperature of 240° C. to 300° C. for 1 hour to 12 hours. For example, the polycondensation reaction may be carried out at a pressure of 0.00001 mmHg to 200 mmHg, 0.0001 mmHg to 100 mmHg, 0.001 mmHg to 50 mmHg, 0.002 mmHg to 10 mmHg, 0.005 mmHg to 3 mmHg, 0.01 mmHg to 1.5 mmHg, or 0.01 mmHg to 1.2 mmHg, and a temperature of 240° C. to 300° C. or 245° C. to 295° C., for 1 hour to 12 hours or 1 hour to 10 hours.

For example, the polycondensation reaction may be carried out by reducing the pressure of the product of the esterification reaction to 4.0 mmHg to 6.0 mmHg or 4.5 mmHg to 5.5 mmHg over 20 minutes to 40 minutes or 25 minutes to 35 minutes, raising the temperature to 240° C. to 300° C. or 245° C. to 295° C. over 0.5 hour to 2 hours or 0.7 hour to 1.2 hours, and maintaining a pressure of 0.01 mmHg to 400 mmHg.

At the beginning of the polycondensation reaction, the stirring speed may be set high. As the polycondensation reaction proceeds, when the stirring power is weakened due to the increase in the viscosity of the reactant or the temperature of the reactant rises above the set temperature, the stirring speed may be appropriately adjusted accordingly.

The melt produced by the polycondensation reaction may have an intrinsic viscosity (IV) of 0.5 dl/g to 1.3 dl/g. For example, the polycondensation reaction may be carried out until the intrinsic viscosity (IV) of the melt produced by the polycondensation reaction becomes 0.5 dl/g to 1.2 dl/g or 0.6 dl/g to 1.15 dl/g.

In addition, a catalyst and/or a stabilizer may be further added in the esterification reaction and the polycondensation reaction.

For example, the catalyst for an esterification reaction may be methylates of sodium and magnesium; acetates, borates, fatty acid salts, and carbonates of Zn, Cd, Mn, Co, Ca, and Ba; metallic Mg; and oxides of Pb, Zn, Sb, and Ge.

In addition, the catalyst for a polycondensation reaction may be, for example, titanium-based catalysts such as tetraethyl titanate, acetyl tripropyl titanate, tetrapropyl titanate, tetrabutyl titanate, polybutyl titanate, 2-ethylhexyl titanate, octylene glycol titanate, lactate titanate, triethanolamine titanate, acetyl acetonate titanate, ethyl acetoacetic ester titanate, isostearyl titanate, titanium dioxide, titanium dioxide/silicon dioxide copolymers, titanium dioxide/zirconium dioxide copolymers; germanium-based catalysts such as germanium dioxide and copolymers using the same; or tin-based catalysts such as monobutyltin oxide, dibutyltinoxide, and monobutylhydroxytinoxide.

In addition, the stabilizer may be a phosphorus-based compound such as phosphoric acid, trimethyl phosphate, and triethyl phosphate may be used, but it is not limited thereto.

The stabilizer may be employed in an amount of 10 ppm to 2,500 ppm based on the total weight of the polycondensation reactant. For example, the stabilizer may be employed in an amount of 150 ppm to 2,300 ppm, 200 ppm to 2,000 ppm, 300 ppm to 1,500 ppm, 50 ppm to 400 ppm, 70 ppm to 350 ppm, or 100 ppm to 300 ppm, based on the total weight of the polycondensation reactant.

### EMBODIMENTS FOR CARRYING OUT THE INVENTION

Hereinafter, the present invention will be described in more detail with reference to the following examples. However, these examples are set forth to illustrate the present invention, and the scope of the present invention is not limited thereto.

### Example

### Preparation of a Polyester Copolymer

### Example 1

### (1) Esterification Reaction

A 10-liter reactor equipped with a column and a condenser for cooling with water was charged with 1,277 g (7.687 moles) of terephthalic acid (TPA), 1,539 g (7.687 moles) of dimethyl cyclohexane dicarboxylate (DMCD), and 1,908 g (30.74 moles) of ethylene glycol (EG). Here, G/A (total diol/total diacid; molar ratio of the diol component to the dicarboxylic acid or its derivative component) was 2.0.

Thereafter, 0.853 g of tetrabutyl titanate (TBT) as a catalyst, 0.235 g of phosphoric acid as a stabilizer, and 1.47 g of trimellitic anhydride as a branching agent were added thereto, followed by stirring thereof.

Thereafter, nitrogen was injected into the reactor containing the mixture to make the pressure in the reactor higher than normal pressure by 1.0 kgf/cm² (absolute pressure: 1,495.6 mmHg). Then, the temperature of the reactor was raised from room temperature to 200° C. over 60 minutes and maintained at 200° C. for 2 hours, and the temperature was then raised again to 245° C. over 5 hours. Thereafter, an esterification reaction was carried out at a temperature of 245° C. for 0.5 hour. In this procedure, by-products were discharged through the column and condenser. Upon completion of the esterification reaction, nitrogen in the pressurized reactor was purged to the outside to lower the pressure in the reactor to normal pressure, and the product of the esterification reaction in the reactor was then transferred to a 7-liter reactor capable of a reaction under vacuum.

### (2) Polycondensation Reaction

Thereafter, the pressure of the reactor containing the product of the esterification reaction was reduced from normal pressure to 5.0 Torr (absolute pressure: 5 mmHg) over 30 minutes. At the same time, the temperature of the reactor was raised to 270° C. over 1 hour, and a polycondensation reaction was carried out while the pressure of the reactor was maintained at 1.0 Torr (absolute pressure: 1.0 mmHg) or less. Here, the stirring speed was set high at the beginning of the polycondensation reaction. As the polycondensation reaction proceeded, when the stirring power was weakened due to the increase in the viscosity of the reactant or the temperature of the reactant rose above the set temperature, the stirring speed was appropriately adjusted accordingly.

The polycondensation reaction was carried out until the intrinsic viscosity (IV) of the melt in the reactor reached 1.0 dl/g or more. The melt was then discharged to the outside of the reactor to form strands, which were solidified with a cooling liquid and then granulated to have an average weight of about 12 mg to 14 mg to prepare a polyester copolymer.

### Examples 2 to 5

Polyester copolymers were prepared in the same manner as in Example 1, except that the components and contents were changed as shown in Table 1 below, respectively.

### Comparative Example 1

Polyethylene terephthalate (PET, manufacturer: Lotte Chemical) was prepared.

### Comparative Example 2

Glycol-modified polyethylene terephthalate (PETG, manufacturer: SK Chemicals) was prepared.

TABLE 1

| | Example 1 | Example 2 | Example 3 | Example 4 | Example 5 |
|---|---|---|---|---|---|
| TPA (g) | 1,277 | 761 | 506 | 745 | 745 |
| DMCD (g) | 1,539 | 2,141 | 2,439 | 2,094 | 2,096 |
| EG (g) | 1,908 | 1,896 | 1,890 | 1,762 | 1,764 |
| DEG (g) | — | — | — | 159 | — |
| NPG (g) | — | — | — | — | 156 |
| Catalyst (g) | 0.217 | 0.217 | 0.217 | 0.217 | 0.217 |
| Stabilizer (g) | 0.434 | 0.434 | 0.434 | 0.434 | 0.434 |
| Branching | 1.470 | 1.470 | — | 1.470 | 1.470 |
| agent (g) | | | | | |

### Test Example

### Test Example 1: Composition of the Polyester Copolymer

The polyester copolymers of Examples 1 to 5 and Comparative Examples 1 and 2 were each dissolved in a CDCl₃ solvent at a concentration of 3 mg/mL. The composition (% by mole) of the polyester copolymer was then measured through a 1H-NMR spectrum obtained using a nuclear magnetic resonance instrument (JEOL, 600 MHz FT-NMR) at 25° C.

### Test Example 2: Intrinsic Viscosity

The polyester copolymers of Examples 1 to 5 and Comparative Examples 1 and 2 were each dissolved in ortho-chlorophenol (OCP) at 150° C. at a concentration of 0.12%, and the intrinsic viscosity (IV, dl/g) was measured with an Ubbelohde viscometer in a thermostat at 35° C.

### Test Example 3: Tg, Tc, and Tm

The polyester copolymers of Examples 1 to 5 and Comparative Examples 1 and 2 were each measured for the glass transition temperature (Tg), crystallization temperature (Tc), and melting temperature (Tm) using a differential scanning calorimeter (DSC).

Specifically, each copolymer was processed at a temperature of 270° C. using an injection molding machine to obtain an injection-molded article of a flat specimen with a thickness of 6 mm. The first scan was obtained by raising the temperature from −20° C. to 280° C. at 10° C./minute and maintaining the temperature at 280° C. for 2 minutes using a differential scanning calorimeter. Thereafter, the second scan was obtained by lowering the temperature from 280° C. to −20° C. at −300° C./minute, maintaining it for 15 minutes, and then raising the temperature again from −20° C. to 280° C. at 10° C./minute. Glass transition temperature (Tg), crystallization temperature (Tc), and melting temperature (Tm) were measured from the heat flow curve obtained by the above procedure.

### Test Example 4: Specific Gravity

The polyester copolymers of Examples 1 to 5 and Comparative Examples 1 and 2 were each measured for the specific gravity according to ASTM D 256.

### Test Example 5: Shore D Hardness

The polyester copolymers of Examples 1 to 5 and Comparative Examples 1 and 2 were each measured for the Shore D hardness according to ASTM D2240-05.

### Test Example 6: Tensile Strength and Tensile Elongation

The polyester copolymers of Examples 1 to 5 and Comparative Examples 1 and 2 were each measured for the tensile strength and tensile elongation according to ASTM D 638.

Specifically, each copolymer was processed at a temperature of 270° C. using an injection molding machine to obtain an injection-molded article of a flat specimen with a thickness of 6 mm. Each injection-molded article was cut to 100 mm in length and 15 mm in width, which was mounted to a universal tester of INSTRON (4206-001, manufacturer: UTM) at a spacing between chucks of 50 mm. Testing was performed at a tensile speed of 50 mm/minute, and the tensile strength was measured with a program installed in the device.

Each injection-molded article was cut to a size of 100 mm in length and 15 mm in width, which was measured for the maximum deformation just before fracture with a universal tester of INSTRON (4206-001, manufacturer: UTM) at a tensile speed of 500 mm/minute. The ratio of the maximum deformation to the initial length was calculated as the tensile elongation.

Here, tensile strength and tensile elongation may be divided into measurement values at the yield point and measurement values at the break point. Yield point refers to the force at the highest point received by a material. Break point refers to the force at which a material breaks. They are each indicated by @ yield and @ break.

TABLE 2

| | Ex. 1 | Ex. 2 | Ex. 3 | Ex. 4 | Ex. 5 | C. Ex. 1 | C. Ex. 2 |
|---|---|---|---|---|---|---|---|
| DMCD | 50 | 70 | 80 | 70 | 70 | 0 | 0 |
| (% by mole) | | | | | | | |
| Intrinsic viscosity | 1.03 | 1.00 | 1.12 | 0.85 | 0.99 | 0.80 | 0.67 |
| (IV, dl/g) | | | | | | | |
| Tg (° C.) | 45 | 30 | 25 | 26 | 31 | 75 | 80 |
| Tc (° C.) | — | — | — | — | — | 130 | — |
| Tm (° C.) | — | — | — | — | — | 260 | — |
| Specific gravity | 1.24 | 1.25 | 1.24 | 1.24 | 1.25 | 1.33 | 1.27 |
| Shore D hardness | 71 | 60 | 45 | 52 | 59 | 80 | 80 |
| Tensile strength | 61 | N/A | N/A | N/A | N/A | 55 | 45 |
| (@ yield, MPa) | | | | | | | |
| Tensile strength | 61 | 34 | 20 | 32 | 28 | 43 | 30 |
| (@ break, MPa) | | | | | | | |
| Tensile elongation | 7.6 | N/A | N/A | N/A | N/A | 4.0 | 4.5 |
| (@ yield, %) | | | | | | | |
| Tensile elongation | 640 | 2300 | 1900 | 2100 | 2400 | 450 | 250 |
| (@ break, %) | | | | | | | |

As can be seen from Table 2 above, the polyester copolymers of Examples 1 to 5 are environmentally friendly, have mechanical properties similar to those of the conventionally used PET and PETG of Comparative Examples 1 and 2, and have intrinsic viscosity, glass transition temperature (Tg), crystallization temperature (Tc), and melting temperature (Tm) satisfying desirable ranges, and are excellent in color characteristics.

1. A polyester copolymer, which comprises a residue of a first dicarboxylic acid component comprising terephthalic acid or a derivative thereof;
a residue of a second dicarboxylic acid component comprising cyclohexane dicarboxylic acid, dimethyl cyclohexane dicarboxylate, or a derivative thereof; and
a residue of a diol component comprising ethylene glycol or a derivative thereof,
wherein the second dicarboxylic acid component is employed in an amount of 30% by mole or more based on the total dicarboxylic acid component.

2. The polyester copolymer of claim 1, wherein the second dicarboxylic acid component is employed in an amount of 50% by mole or more based on the total dicarboxylic acid component.

3. The polyester copolymer of claim 1, wherein the second dicarboxylic acid component comprises dimethyl cyclohexane dicarboxylate or a derivative thereof, and the dimethyl cyclohexane dicarboxylate or a derivative thereof is employed in an amount of 60% by mole or more based on the total dicarboxylic acid component.

4. The polyester copolymer of claim 1, which comprises a residue of a third dicarboxylic acid comprising at least one selected from the group consisting of succinic acid, adipic acid, sebacic acid, azelaic acid, dodecanoic acid, isophthalic acid, orthophthalic acid, naphthalenedicarboxylic acid, dimethyl terephthalate, dimethyl isophthalate, diethyl terephthalate, diethyl isophthalate, dibutyl terephthalate, and dibutyl isophthalate.

5. The polyester copolymer of claim 1, which comprises a residue of a first diol component comprising the ethylene glycol or a derivative thereof, and a residue of a second diol component comprising at least one selected from the group consisting of propanediol, butanediol, pentanediol, hexanediol, cyclohexanedimethanol, neopentyl glycol, diethylene glycol, and triethylene glycol.

6. The polyester copolymer of claim 5, wherein the molar ratio of the first diol component is 80% by mole or more.

7. The polyester copolymer of claim 1, wherein the polyester copolymer is a block copolymer or a random copolymer.

8. The polyester copolymer of claim 1, wherein the polyester copolymer has a glass transition temperature (Tg) of 10° C. to 70° C. when measured by differential scanning calorimetry (DSC).

9. The polyester copolymer of claim 1, wherein the polyester copolymer has an intrinsic viscosity (IV) of 0.5 dl/g to 1.3 dl/g.

10. The polyester copolymer of claim 1, wherein the polyester copolymer has a specific gravity of 1.2 or more and a Shore D hardness of 20 to 95.

11. The polyester copolymer of claim 1, wherein the polyester copolymer has a tensile strength (@ break) of 10 MPa to 70 MPa and a tensile elongation (@ break) of 200% to 3,500%.
